(19) United States
(12) Patent Application Publication
(10) Pub. No.: US 2026/0201284 A1
(43) Pub. Date: Jul. 16, 2026

(54) METHOD FOR PRODUCING DETERGENTS OR CLEANING AGENTS

(71) Applicant: HENKEL AG & CO. KGAA, Düsseldorf (DE)

(72) Inventors: Oliver KURTH, Langenfeld (DE); Karl-Josef VON DEN DRIESCH, Monheim (DE); Michael KREIS, Leverkusen (DE); Robert Stephen CAPPLEMAN, Duisburg (DE)

(21) Appl. No.: 19/134,718

(22) PCT Filed: Nov. 3, 2023
(86) PCT No.: PCT/EP2023/080719

§ 371 Date: May 31, 2025

(30) Foreign Application Priority Data
Dec. 12, 2022 (DE) 10 2022 213 453.2

(51) Int. Cl. C11D 17/00; C11D 3/20; C11D 3/37

(52) U.S. Cl. CPC C11D 17/003; C11D 3/2044; C11D 3/2065; C11D 3/2079; C11D 3/3707; C11D 3/3753

(57) ABSTRACT

A method for producing a detergent or cleaning agent is described. The detergent or cleaning agent includes 4 to 40 wt. % of a gelling agent, 0.1 to 40 wt. % of a detergent- or cleaning-active ingredient, and 30 to 90 wt. % of an organic solvent. The method includes providing the organic solvent at a temperature above 10° C., introducing a first gelling agent preparation into the organic solvent, introducing a second gelling agent preparation into the organic solvent, and introducing a detergent- or cleaning-active ingredient into the organic solvent.

The present invention relates to a method for producing detergent or cleaning agents. In particular, the application relates to a multi-stage production method during which gelling agents are dosed into a liquid receiver at different times.

Continuously changing requirements are placed on the packaging and product forms of detergent or cleaning agents. The main focus has, for quite some time, been on the convenient dosing of detergent or cleaning agents by the consumer and the simplification of the work steps required to carry out a washing or cleaning method. A solution is provided by pre-portioned detergent or cleaning agents, for example film pouches having one or more receiving chambers for solid or liquid compositions, with a particular technical focus on the development and production of liquid or gel-like detergents that are suitable for packaging in water-soluble film pouches.

To be commercially successful, a detergent or cleaning agent portion unit must meet the interests of consumers as effectively as possible. A substantial means of communicating product quality and product claims is the appearance, including the shape, color and transparency of a portion unit. This applies in particular to water-soluble film pouches, the soluble films of which are generally transparent and give a clear view of the solid or liquid detergent or cleaning agents they contain. While colored clear, i.e., non-white, liquid detergents can be obtained in a simple manner by adding appropriate dyes, the provision of white or colored-cloudy liquid detergents or detergent or cleaning agent gels is more challenging because the opacifying agents used for their production are increasingly being viewed in a critical light for ecological reasons. Against this background, the provision of an ecologically acceptable opacifying agent is a relevant development objective in the field of liquid detergent or cleaning agents.

Liquid detergent or cleaning agents are generally produced by means of a sequential method, during which the ingredients of the detergent are mixed with one another in a temporal sequence. To achieve a homogeneous end product, the respective intermediate products and the end product are mixed, with input of energy. The end product is not only distinguished by the most homogeneous distribution of active ingredients possible, but also by rheological properties suitable for handling by the consumer. The type and time of adjustment of these rheological properties during the production method influences the efficiency of the method as well as the final product quality, since the rheological properties of the intermediate and end products are closely related to the amount of energy to be input for homogenization during production and the mechanical load on the intermediate and end products and the components thereof.

Another feature of efficient production methods for detergent or cleaning agent portion units is the amount of returns and waste generated in these methods and the possibility of recycling these returns and waste. Returns include, for example, portion units with an insufficient fill level or a poor appearance; waste arises, for example, as offcuts when packaging the portion units in water-soluble film pouches.

Methods for reusing detergents from water-soluble film pouches are described, for example, in European patents EP 1 462 513 B1, EP 2 941 479 B1 and EP 3 037 512 B1.

The object of the present application was to provide an efficient method for producing gel-like detergent or cleaning agents, wherein the products of the method should be characterized by good solubility and a pleasant feel and appearance.

This object is achieved by a method for producing a detergent or cleaning agent, containing, based on its total weight
a) 4 to 40 wt. % of a gelling agent;
b) 0.1 to 40 wt. % of a detergent- or cleaning-active ingredient;
c) 30 to 90 wt. % of an organic solvent;
said method comprising the steps of:
   i) providing the organic solvent at a temperature T₁ above 10° C.,
   ii) providing a first gelling agent preparation and introducing the first gelling agent preparation into the organic solvent;
   iii) providing a second gelling agent preparation which differs from the first gelling agent preparation and introducing the second gelling agent preparation into the organic solvent,
      wherein the detergent- or cleaning-active ingredient is introduced into the organic solvent after step i), thereby forming a detergent- and cleaning-active composition.

The method according to the invention is used to produce detergent or cleaning agents. The liquefaction point of the detergent or cleaning agents is preferably at temperatures above 80° C. (1013 mbar), particularly preferably above 100° C. (1013 mbar) and in particular above 115° C. (1013 mbar).

The rheological properties of the detergent or cleaning agent are particularly influenced by, among other components, the gelling agent present. In preferred detergent or cleaning agents, the proportion by weight of the gelling agent relative to the total weight is 6 to 30 wt. %, preferably 7 to 24 wt. %, and in particular 8 to 22 wt. %.

Preferred gelling agents are selected from the group of polymeric gelling agents, preferably from the group of optionally acetalized polyvinyl alcohol, gelatins and xanthan or mixtures thereof. The use of optionally acetalized polyvinyl alcohol is very particularly preferred.

Preferably, the gelling agent of the first gelling agent preparation and the gelling agent of the second gelling agent preparation are selected from the group of polymeric gelling agents, preferably from the group of optionally acetalized polyvinyl alcohol, gelatins and xanthan or mixtures thereof, very particularly preferably from the group of optionally acetalized polyvinyl alcohols.

Preferred gelling agents are preferably based on a polyvinyl alcohol or a polyvinyl alcohol copolymer of which the molecular weight is in the range of from 10,000 to 1,000,000 gmol⁻¹, preferably from 20,000 to 500,000 gmol⁻¹, particularly preferably from 30,000 to 100,000 gmol⁻¹, and in particular from 40,000 to 80,000 gmol⁻¹.

The production of the polyvinyl alcohol and polyvinyl alcohol copolymers generally includes the hydrolysis of intermediate polyvinyl acetate. Preferred polyvinyl alcohols and polyvinyl alcohol copolymers have a degree of hydrolysis of 70 to 100 mol. %, preferably 80 to 90 mol. %, particularly preferably 81 to 89 mol. %, and in particular 82 to 88 mol. %.

Preferred polyvinyl alcohol copolymers comprise, in addition to vinyl alcohol, an ethylenically unsaturated carboxylic acid, the salt thereof, or the ester thereof. In addition to vinyl alcohol, polyvinyl alcohol copolymers of this kind particularly preferably contain sulfonic acids such as 2-acrylamido-2-methyl-1-propane sulfonic acid (AMPS), acrylic acid, methacrylic acid, acrylic acid ester, methacrylic acid ester, or mixtures thereof; of the esters, C₁₋₄ alkyl esters or C₁₋₄ hydroxyalkyl esters are preferred. Ethylenically unsaturated dicarboxylic acids, for example itaconic acid, maleic acid, fumaric acid and mixtures thereof, are possible as further monomers.

The gelling agent is preferably selected from the group of hydrolyzed polyvinyl alcohol homopolymers and polyvinyl alcohol copolymers having a molar mass of from 30,000 to 60,000 g/mol.

As a second optional constituent, the detergent or cleaning agent contains a detergent- or cleaning-active ingredient. The proportion by weight of the detergent- or cleaning-active ingredient relative to the total weight of the detergent or cleaning agent is preferably 1 to 35 wt. %, preferably 5 to 30 wt. %, and in particular 10 to 25 wt. %.

Although the selection of the detergent- or cleaning-active ingredient is not subject to any substantial restriction, detergent- or cleaning-active ingredients selected from the group of detergent- or cleaning-active polymers, surfactants, corrosion inhibitors and mixtures thereof are preferred because of their ease of processability in the detergent or cleaning agent.

The group of detergent- or cleaning-active polymers includes, in particular, polycarboxylates. The detergent- or cleaning-active ingredient is preferably selected from the group of the polycarboxylates, in particular the copolymeric polyacrylates, particularly preferably the copolymeric polyacrylates containing sulfonic acid groups.

The copolymers can have two, three, four, or more different monomer units. Preferred copolymeric polysulfonates contain, in addition to sulfonic acid group-containing monomer(s), at least one monomer from the group of unsaturated carboxylic acids.

As unsaturated carboxylic acid(s), unsaturated carboxylic acids of formula R¹(R²)C═C(R³)COOH are particularly preferably used in which R¹ to R³ represent, independently of one another, —H, —CH₃, a straight-chain or branched saturated alkyl radical having 2 to 12 carbon atoms, a straight-chain or branched, mono- or polyunsaturated alkenyl radical having 2 to 12 carbon atoms, with —NH₂, —OH, or —COOH-substituted alkyl or alkenyl radicals as defined above, or represent —COOH or —COOR⁴, where R⁴ is a saturated or unsaturated, straight-chain or branched hydrocarbon radical having 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic anhydride, fumaric acid, itaconic acid, citraconic acid, methylene malonic acid, sorbic acid, cinnamic acid, or mixtures thereof. It is also possible, of course, to use the unsaturated dicarboxylic acids.

For sulfonic acid group-containing monomers, those of the formula R⁵(R⁶)C═C(R⁷)—X—SO₃H are preferred, in which R⁵ to R⁷, independently of one another, represent —H, —CH₃, a straight-chain or branched saturated alkyl functional group having 2 to 12 carbon atoms, a straight-chain or branched, mono- or polyunsaturated alkenyl functional group having 2 to 12 carbon atoms, —NH₂, —OH, or —COOH-substituted alkyl or alkenyl functional groups, or represent —COOH or —COOR⁴, where R⁴ is a saturated or unsaturated, straight-chain or branched hydrocarbon functional group having 1 to 12 carbon atoms, and X represents an optionally present spacer group that is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Among these monomers, those of formulas

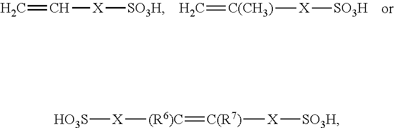

are preferred, in which R⁶ and R⁷ are selected, independently of one another, from —H, —CH₃, —CH₂CH₃, —CH₂CH₂CH₃ and —CH(CH₃)₂, and X represents an optionally present spacer group that is selected from —(CH₂)ₙ—, where n=0 to 4, —COO—(CH₂)ₖ—, where k=1 to 6, —C(O)—NH—C(CH₃)₂—, —C(O)—NH—C(CH₃)₂—CH₂— and —C(O)—NH—CH(CH₃)—CH₂—.

Particularly preferred sulfonic acid group-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxy-propanesulfonic acid, allyl sulfonic acid, methallyl sulfonic acid, allyloxybenzene sulfonic acid, methallyloxybenzene sulfonic acid, 2-hydroxy-3-(2-propenyloxy)propanesulfonic acid, 2-methyl-2-propene-1-sulfonic acid, styrene sulfonic acid, vinylsulfonic acid, 3-sulfopropyl acrylate, 3-sulfopropyl methacrylate, sulfomethacrylamide, sulfomethylmethacrylamide, as well as mixtures of the above acids or water-soluble salts thereof. The sulfonic acid groups can be present in the polymers fully or partially in neutralized form, i.e., the acidic hydrogen atom of the sulfonic acid group can be replaced in some or all of the sulfonic acid groups with metal ions, preferably alkali metal ions, and in particular with sodium ions. The use of partially or fully neutralized sulfonic acid group-containing copolymers is preferred according to the invention.

In copolymers that contain only carboxylic acid group-containing monomers and sulfonic acid group-containing monomers, the monomer distribution of the copolymers that are preferably used according to the invention is preferably from 5 to 95 wt. % in each case; particularly preferably, the proportion of the sulfonic acid group-containing monomer is from 50 to 90 wt. %, and the proportion of the carboxylic acid group-containing monomer is from 10 to 50 wt. %, with the monomers preferably being selected from those mentioned above. The molar mass of the sulfo-copolymers that are preferably used according to the invention can be varied in order to adapt the properties of the polymers to the desired intended purpose. Preferred cleaning agents are characterized in that the copolymers have molar masses from 2,000 to 200,000 g·mol⁻¹, preferably from 4,000 to 25,000 g·mol⁻¹ and in particular from 5,000 to 15,000 g·mol⁻¹.

In another preferred embodiment, the copolymers also comprise, in addition to carboxyl group-containing monomers and sulfonic acid group-containing monomers, at least one non-ionic, preferably hydrophobic monomer. In particular, the rinsing performance of dishwashing detergents according to the invention was able to be improved through the use of these hydrophobically modified polymers.

Particularly preferably, the at least one second phase further comprises an anionic copolymer, with a copolymer comprising
i) carboxylic acid group-containing monomers
ii) sulfonic acid group-containing monomers
iii) non-ionic monomers, in particular hydrophobic monomers being used as the anionic copolymer.

As non-ionic monomers, monomers of general formula R¹(R²)C═C(R³)—X—R⁴ are preferably used, in which R¹ to R³ represent, independently of one another, —H, —CH₃ or —C₂H₅, X represents an optionally present spacer group selected from —CH₂—, —C(O)O— and —C(O)—NH—, and R⁴ represents a straight-chain or branched saturated alkyl functional group having 2 to 22 carbon atoms or an unsaturated, preferably aromatic functional group having 6 to 22 carbon atoms.

Particularly preferred non-ionic monomers are butene, isobutene, pentene, 3-methylbutene, 2-methylbutene, cyclopentene, hexene, hexene-1,2-methlypentene-1,3-methylpentene-1, cyclohexene, methylcyclopentene, cycloheptene, methylcyclohexene, 2,4,4-trimethylpentene-1,2,4,4-trimethylpentene-2,2,3-dimethylhexene-1,2,4-dimethylhexene-1,2,5-dimethylhexene-1,3,5-dimethylhexene-1,4,4-dimethylhexane-1, ethylcyclohexyne, 1-octene, α-olefins having 10 or more carbon atoms, for example 1-decene, 1-dodecene, 1-hexadecene, 1-octadecene and C₂₂ α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid-2-ethylhexyl ester, methacrylic acid-2-ethylhexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide or mixtures thereof, in particular acrylic acid, ethyl acrylate, 2-acrylamido-2-methylpropanesulfonic acid (AMPS) and mixtures thereof.

The proportion by weight of the detergent- or cleaning-active ingredient from the group of the polycarboxylates, in particular the copolymeric polyacrylates, particularly preferably the copolymeric polyacrylates containing sulfonic acid groups, relative to the total weight of the detergent or cleaning agent is preferably 1 to 18 wt. %, preferably 2 to 16 wt. % and in particular 4 to 14 wt. %.

Another group of preferred detergent- or cleaning-active ingredients are the non-ionic surfactants, preferably non-ionic surfactants having a melting point above 30° C., particularly preferably in the range of from 40 to 60° C. The melting point of the surfactant (in ° C.) is determined using differential scanning calorimetry (DSC) according to ISO standard 11357. In this case, the peak temperature which can be determined using DSC in the second heating run is considered to be the melting point within the meaning of the invention. This is the temperature at which the vertex/maximum extent (on the y axis) is on the DSC graph. If several peaks are present in a surfactant (commercial product) within the limits of 5% of the maximum extent observed in the second heating run, the temperature of the first peak is considered to be the melting point according to the invention.

Suitable surfactants are in particular linear, saturated fatty acid alcohol ethoxylates having 14 to 18 C atoms in the alkyl chain and 10 to 100 ethylene oxide units, which are preferably not end-capped.

Other preferred non-ionic surfactants are ethoxylated monohydroxy alkanols or alkyl phenols that additionally have polyoxyethylene-polyoxypropylene block copolymer units. The alcohol or alkylphenol fraction of such non-ionic surfactant molecules preferably constitutes more than 30 wt. %, particularly preferably more than 50 wt. %, and in particular more than 70 wt. % of the total molar mass of such non-ionic surfactants. Preferred agents are characterized in that they contain ethoxylated and propoxylated non-ionic surfactants in which the propylene oxide units in the molecule constitute up to 25 wt. %, preferably up to 20 wt. %, and particularly up to 15 wt. % of the total molar mass of the non-ionic surfactant.

Preferably, the detergent- or cleaning-active ingredient is selected from the group of the non-ionic surfactants of formula (I)

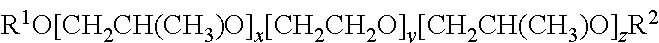

where
R¹ represents a linear or branched aliphatic hydrocarbon radical having 4 to 22 carbon atoms,
R² represents a preferably hydrolyzed linear or branched hydrocarbon radical having 2 to 26 carbon atoms,
x and z represent values from 0 to 40, and
y represents a value of at least 15.

In a further preferred embodiment, the detergent- or cleaning-active ingredient is selected from the group of the non-ionic surfactants of formula (II)

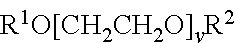

where
R¹ represents a linear or branched aliphatic hydrocarbon radical having 4 to 22 carbon atoms,
R² represents a preferably hydroxylated linear or branched hydrocarbon radical having 2 to 26 carbon atoms,
y represents a value of from 15 to 120, preferably 20 to 100 and in particular 35 to 85.

Preferred classes of surfactants of this kind have, as R¹ or R², independently of one another, 6 to 20, preferably 8 to 14 C atoms in the alkyl chain, and comprise 40 to 150, preferably 40 to 80 alkoxyl units, preferably ethylene oxide (EO) and/or propylene oxide (PO) units, in particular ethylene oxide units. Particularly preferred are those surfactants of formula (II), in which R¹ represents a linear or branched aliphatic hydrocarbon functional group having 8 to 14 carbon atoms, R² represents a linear or branched hydrocarbon functional group having 8 to 20 carbon atoms, and which have 40 to 80 ethylene oxide units.

The non-ionic surfactants described above have a particularly advantageous effect on the processability, for example the dosability or the setting behavior of the detergent or cleaning agents.

Based on their total weight, preferred detergent or cleaning agents contain the non-ionic surfactant in quantities of from 0.5 to 15 wt. %, preferably 2 to 12 wt. %, and in particular 4 to 10 wt. %.

As a further preferred detergent- or cleaning-active ingredient, preferred detergent or cleaning agents contain a detergent- or cleaning-active ingredient from the group of glass corrosion inhibitors, preferably water-soluble zinc salts, particularly preferably zinc sulfate and zinc acetate, in particular zinc acetate.

The proportion by weight of the glass corrosion inhibitor relative to the total weight of the detergent or cleaning agent is preferably 0.05 to 3 wt. %, more preferably 0.1 to 2.4 wt. % and in particular 0.21 to 1 wt. %.

The detergent or cleaning agents preferably further contain a consistency agent from the group of polyethylene glycols, preferably from the group of polyethylene glycols having an average molar mass of 200 to 600 g/mol, preferably from the group of polyethylene glycols having an average molar mass of 300 to 500 g/mol. The proportion by weight of the consistency agent relative to the total weight of the detergent or cleaning agent is preferably 5 to 30 wt. %, more preferably from 8 to 26 wt. % and in particular 10 to 22 wt. %.

As in the case of the non-ionic surfactants described above, the use of the consistency agent has proven to be advantageous with regard to the processability, for example the dosability or the setting behavior of the detergent or cleaning agents.

The third substantial constituent of the detergent or cleaning agent is organic solvent. The proportion by weight of the organic solvent relative to the total weight of the detergent or cleaning agent is preferably 35 to 80 wt. % and in particular 40 to 70 wt. %.

The use of organic solvents from the group of the polyhydric alcohols has proven to be particularly advantageous for processability and setting behavior.

For the purpose of the present invention, polyhydric alcohols are hydrocarbons in which two, three or more hydrogen atoms are replaced by OH groups. The OH groups are each bonded to different carbon atoms. No carbon atom has two OH groups.

Particularly preferably, the at least one gel phase comprises at least one alkanetriol and/or at least one alkanediol, in particular at least one C₃ to C₁₀ alkanetriol and/or at least one C₃ to C₁₀ alkanediol, preferably at least one C₃ to C₈ alkanetriol and/or at least one C₃ to C₈ alkanediol, particularly at least one C₃ to C₆ alkanetriol and/or at least one C₃ to C₅ alkanediol, as a polyhydric alcohol. The combination of a C₃ to C₁₀ alkanediol with a C₃ to C₁₀ alkanetriol is particularly preferred. The use of organic solvent selected from the group of 1,3-propanediol and glycerol is very particularly preferred.

Preferred detergent or cleaning agents, based on their total weight, contain water in a quantity by weight of below 5 wt. %, preferably below 2 wt. % and in particular below 0.5 wt. %.

The composition of the framework formulation of a detergent or cleaning agent produced by means of the method can be found in the table below.

| | wt. % |
|---|---|
| Water-soluble zinc salt (preferably zinc acetate) | 0.0-1.0 |
| Glycerol | 20-45 |
| Propanediol (preferably 1,3-propanediol) | 10-30 |
| Polymer comprising monomers with carboxylate- and sulfonic | 5-20 |
| acid-containing groups | |
| Non-ionic surfactant(s), preferably having a melting point | 0.8-7.0 |
| of greater than 34° C. | |
| Polyethylene glycol avg. molar mass 1,000-2,000 | 0-8 |
| Polyethylene glycol avg. molar mass 200-600 | 10-22 |
| Thickening agent (PVOH) | 10-22 |
| Processing aids | 0-5 |
| Dye solution | 0.0-0.5 |

In step i) of the method, organic solvent is provided at a temperature T₁ above 10° C. It has proven advantageous for the duration of the method and the properties of the product of the method if the organic solvent provided in step i) has a temperature T₁ above 40° C., preferably above 60° C. and in particular in the range from 70 to 120° C.

It is also advantageous for conducting the method if the organic solvent provided in step i) comprises a consistency agent from the group of polyethylene glycols, preferably from the group of polyethylene glycols having an average molar mass of 200 to 600 g/mol, preferably from the group of polyethylene glycols having an average molar mass of 300 to 500 g/mol.

The proportion by weight of the consistency agent relative to the total weight of the organic solvent provided in step i) is preferably 5 to 30 wt. %, in particular 10 to 25 wt. %.

The detergent- or cleaning-active ingredient is introduced after step i). The detergent- or cleaning-active ingredient introduced can be in liquid or solid form. However, in view of the desired solidification of the detergent or cleaning agent in the later course of the method, it is preferred if the detergent- or cleaning-active ingredient is introduced in solid form or at least in partially solid form.

The detergent- or cleaning-active ingredient can be introduced in a single step (as a total amount) or stepwise (in partial amounts). The introduction takes place after step i), for example after step i) and before step ii), at the same time as step ii), after step ii) and before step iii), at the same time as step iii) or after step iii). It is particularly preferable to add the detergent- or cleaning-active ingredient after step i) and before step ii) or after step ii).

In step ii) of the method, the first gelling agent preparation is provided and introduced into the organic solvent provided in step i). In the first gelling agent preparation, the gelling agent can be in solid form, for example as a powder, or in liquid form, for example as a solution or dispersion.

A first preferred method variant comprises the steps of
i) providing the organic solvent at a temperature T₁ above 10° C.,
ii) providing a first solid gelling agent preparation and introducing the first gelling agent preparation into the organic solvent;
iii) providing a second liquid gelling agent preparation which differs from the first gelling agent preparation and introducing the second gelling agent preparation into the organic solvent,
wherein the detergent- or cleaning-active ingredient is introduced into the organic solvent after step i), thereby forming a detergent- and cleaning-active composition.

A second preferred method variant comprises the steps of
i) providing the organic solvent at a temperature T₁ above 10° C.,
ii) providing a first liquid gelling agent preparation and introducing the first gelling agent preparation into the organic solvent;
iii) providing a second solid gelling agent preparation which differs from the first gelling agent preparation and introducing the second gelling agent preparation into the organic solvent,
wherein the detergent- or cleaning-active ingredient is introduced into the organic solvent after step i), thereby forming a detergent- and cleaning-active composition.

In the context of the method, a solid gelling agent preparation is used. A preferred solid gelling agent preparation has a particle size distribution in which at least 70 wt. % of the particles, preferably at least 80 wt. % of the particles, have a particle size below 1000 μm, preferably below 800 μm and in particular below 200 μm. This particle size distribution has proven to be advantageous, in particular with regard to the homogeneous incorporation of the gelling agent into the organic solvent.

Preferably, the solid gelling agent preparation which is introduced into the organic solvent, based on its total weight, has a proportion by weight of gelling agent above 60 wt. %, preferably above 80 wt. % and in particular in the range from 85 to 99 wt. %.

In addition to the solid gelling agent preparation, a liquid gelling agent preparation is also used in the method. It is particularly preferable to introduce the liquid gelling agent preparation into the organic solvent in the form of a solution or a dispersion of the gelling agent in an organic solvent.

If the liquid gelling agent preparation is in the form of a dispersion, said dispersion preferably contains the gelling agent in the form of particles having a maximum dimension of from 2 to 100 mm, preferably from 5 to 60 mm and in particular from 10 to 30 mm. The use of film particles is very particularly preferred.

The incorporation of particles, for example film particles, of the aforementioned dimensions has proven to be advantageous, in particular with regard to achieving a transparent, cloudy appearance. Surprisingly, this appearance can be achieved using the described method without the use of additional opacifying agents.

If the liquid gelling agent preparation is in the form of a solution, the solution of the gelling agent has a temperature of from 30 to 120° C., preferably from 50 to 110° C. and in particular from 70 to 100° C. when it is introduced into the organic solvent initially charged in step i).

The proportion by weight of the gelling agent relative to the total weight of the liquid gelling agent preparation is preferably from 1 to 20 wt. %, more preferably 2 to 15 wt. % and in particular 4 to 12 wt. %.

The weight ratio of the gelling agent introduced by means of a solid gelling agent preparation to the gelling agent introduced by means of a liquid gelling agent preparation is preferably in the range from 1000:1 to 20:1, preferably 800:1 to 40:1 and in particular 600:1 to 60:1.

While method step i) precedes the remaining method steps, method steps ii) and iii) can be carried out consecutively or simultaneously. With regard to the duration of the method, the necessary energy input and the properties of the product of the method, it has proven to be advantageous if step ii) and step iii) are carried out consecutively.

In order to reduce the method complexity and to better control the products of the method, it is advantageous if the same gelling agent is introduced into the liquid detergent- or cleaning-active mixture in step ii) and step iii). Gelling agents that have the same functional groups are referred to as “the same.” It has proven particularly advantageous to introduce gelling agents from the group of the polyvinyl alcohols in step ii) and step iii).

To accelerate the method, after introduction of the first gelling agent preparation in step ii) or after introduction of the second gelling agent preparation in step iii) or after introduction of detergent- or cleaning-active ingredient, the temperature of the organic solvent can be raised to a temperature T₂ above the temperature T₁, wherein the temperature difference of T₂ to T₁ is preferably at least 20° C., more preferably at least 25° C. and in particular at least 30° C.

Preferably, after step ii) or after introduction of the second gelling agent preparation in step iii) or after introduction of detergent- or cleaning-active ingredient, the gelling agent-containing organic solvent is stirred for a period t₁ of from 0.5 to 12 hours, preferably from 1 to 6 hours and in particular from 1 to 3 hours. In preferred method variants, during the period t₁, the gelling agent-containing organic solvent has a temperature T₂ above the temperature T₁, wherein the temperature difference of T₂ to T₁ is preferably at least 15° C., more preferably at least 20° C. and in particular at least 40° C.

To improve the product appearance, a dye can be introduced into the liquid detergent- or cleaning-active preparation in a further step iv) after step iii).

The method is preferably carried out discontinuously, for example in a stirred tank. The quantities provided by the method are naturally higher than those required for a single washing or cleaning cycle. In a preferred method variant, the liquid detergent- or cleaning-active preparation is portioned in a further step v) after step iii). To this end, after step iii), preferably after step iv), in a further step v), the liquid detergent- or cleaning-active preparation is poured, for example into a recess or into a receiving chamber obtained by deforming a water-soluble film.

Preferably, the liquid detergent- or cleaning-active preparation solidifies after step iii), preferably after step v), upon cooling, to form a gel-like body.

This application provides, inter alia, the following subjects:
1. A method for producing a detergent or cleaning agent, containing, based on its total weight
   a) 4 to 40 wt. % of a gelling agent;
   b) 0.1 to 40 wt. % of a detergent- or cleaning-active ingredient;
   c) 30 to 90 wt. % of an organic solvent;
   said method comprising the steps of:
      i) providing the organic solvent at a temperature T₁ above 10° C.,
      ii) providing a first gelling agent preparation and introducing the first gelling agent preparation into the organic solvent;
      iii) providing a second gelling agent preparation which differs from the first gelling agent preparation and introducing the second gelling agent preparation into the organic solvent,
wherein the detergent- or cleaning-active ingredient is introduced into the organic solvent after step i), thereby forming a detergent- and cleaning-active composition.
2. The method according to point 1, wherein the proportion by weight of the gelling agent relative to the total weight of the detergent or cleaning agent is 6 to 30 wt. %, preferably 7 to 24 wt. % and in particular 8 to 22 wt. %.
3. The method according to one of the preceding points, wherein the gelling agent, preferably the gelling agent of the first gelling agent preparation and the gelling agent of the second gelling agent preparation are selected from the group of polymeric gelling agents, preferably from the group of polyvinyl alcohol, gelatins and xanthan or mixtures thereof.
4. The method according to one of the preceding points, wherein the gelling agent is selected from the group of hydrolyzed polyvinyl alcohol homopolymers and polyvinyl alcohol copolymers having a molar mass of from 30,000 to 60,000 g/mol.
5. The method according to one of the preceding points, wherein the proportion by weight of the detergent- or cleaning-active ingredient relative to the total weight of the detergent or cleaning agent is 1 to 35 wt. %, preferably 5 to 30 wt. %, and in particular 10 to 25 wt. %.
6. The method according to one of the preceding points, wherein the detergent- or cleaning-active ingredient is selected from the group of detergent- or cleaning-active polymers, surfactants, corrosion inhibitors and mixtures thereof.
7. The method according to one of the preceding points, wherein the detergent- or cleaning-active ingredient is selected from the group of the polycarboxylates, in particular the copolymeric polyacrylates, particularly preferably the copolymeric polyacrylates containing sulfonic acid groups.
8. The method according to point 7, wherein the proportion by weight of the detergent- or cleaning-active ingredient from the group of the polycarboxylates relative to the total weight of the detergent or cleaning agent is 1 to 18 wt. %, preferably 2 to 16 wt. % and in particular 4 to 14 wt. %.
9. The method according to one of the preceding points, wherein the detergent- or cleaning-active ingredient is selected from the group of non-ionic surfactants, preferably non-ionic surfactants having a melting point above 30° C., preferably in the range from 40 to 60° C.
10. The method according to one of the preceding points, wherein the detergent- or cleaning-active ingredient is selected from the group of the non-ionic surfactants of formula (I)

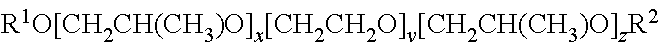

where
   R¹ represents a linear or branched aliphatic hydrocarbon radical having 4 to 22 carbon atoms,
   R² represents a preferably hydroxylated linear or branched hydrocarbon radical having 2 to 26 carbon atoms,
   x and z represent values from 0 to 40, and
   y represents a value of at least 15.
11. The method according to one of the preceding points, wherein the detergent- or cleaning-active ingredient is selected from the group of the non-ionic surfactants of formula (II)

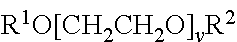

where
   R¹ represents a linear or branched aliphatic hydrocarbon radical having 4 to 22 carbon atoms,
   R² represents a preferably hydroxylated linear or branched hydrocarbon radical having 2 to 26 carbon atoms,
   y represents a value of from 15 to 120, preferably 20 to 100 and in particular 35 to 85.
12. The method according to one of points 9 to 11, wherein the proportion by weight of the non-ionic surfactant relative to the total weight of the detergent or cleaning agent is 0.5 to 15 wt. %, preferably 2 to 12 wt. %, and in particular 4 to 10 wt. %.
13. The method according to one of the preceding points, wherein the detergent- or cleaning-active ingredient is selected from the group of glass corrosion inhibitors, preferably water-soluble zinc salts, particularly preferably zinc sulfate and zinc acetate, in particular zinc acetate.
14. The method according to point 13, wherein the proportion by weight of the glass corrosion inhibitor relative to the total weight of the detergent or cleaning agent is 0.05 to 3 wt. %, preferably 0.1 to 2.4 wt. % and in particular 0.21 to 1 wt. %.
15. The method according to one of the preceding points, wherein the detergent or cleaning agent further contains a consistency agent from the group of polyethylene glycols, preferably from the group of polyethylene glycols having an average molar mass of 200 to 600 g/mol, preferably from the group of polyethylene glycols having an average molar mass of 300 to 500 g/mol.
16. The method according to point 15, wherein the proportion by weight of the consistency agent relative to the total weight of the detergent or cleaning agent is 5 to 30 wt. %, preferably 8 to 26 wt. % and in particular 10 to 22 wt. %.
17. The method according to one of the preceding points, wherein the proportion by weight of the organic solvent relative to the total weight of the detergent or cleaning agent is 35 to 80 wt. %, preferably 40 to 70 wt. %.
18. The method according to one of the preceding points, wherein the organic solvent is selected from the group of polyhydric alcohols.
19. The method according to one of the preceding points, wherein the organic solvent comprises a C₃ to C₁₀ alkanediol and a C₃ to C₁₀ alkanetriol.
20. The method according to one of the preceding points, wherein the organic solvent is selected from the group of 1,3-propanediol and glycerol.
21. The method according to one of the preceding points, wherein the detergent or cleaning agent, based on its total weight, contains water in a quantity by weight of below 5 wt. %, preferably below 2 wt. % and in particular below 0.5 wt. %.
22. The method according to one of the preceding points, wherein the organic solvent provided in step i) has a temperature T₁ above 40° C., preferably above 60° C. and in particular in the range from 70 to 120° C.
23. The method according to one of the preceding points, wherein the organic solvent provided in step i) comprises a consistency agent from the group of polyethylene glycols, preferably from the group of polyethylene glycols having an average molar mass of 200 to 600 g/mol, preferably from the group of polyethylene glycols having an average molar mass of 300 to 500 g/mol.
24. The method according to one of the preceding points, wherein the organic solvent provided in step i) contains a consistency agent in a proportion by weight of from 5 to 30 wt. %, preferably from 10 to 25 wt. %.
25. The method according to one of the preceding points, wherein the detergent- or cleaning-active ingredient is introduced into the organic solvent after step i) at least partially and preferably entirely in solid form.
26. The method according to one of the preceding points, wherein the detergent- or cleaning-active ingredient is introduced into the organic solvent in partial amounts.
27. The method according to one of the preceding points, wherein the detergent- or cleaning-active ingredient is introduced into the organic solvent after step i) and before step ii).
28. The method according to one of the preceding points, wherein the detergent- or cleaning-active ingredient is introduced into the organic solvent after step ii).
29. The method according to one of the preceding points, comprising the steps of
   i) providing the organic solvent at a temperature T₁ above 10° C.,
   ii) providing a first solid gelling agent preparation and introducing the first gelling agent preparation into the organic solvent;
   iii) providing a second liquid gelling agent preparation which differs from the first gelling agent preparation and introducing the second gelling agent preparation into the organic solvent,
   wherein the detergent- or cleaning-active ingredient is introduced into the organic solvent after step i), thereby forming a detergent- and cleaning-active composition.
30. The method according to one of the preceding points, comprising the steps of
   i) providing the organic solvent at a temperature T₁ above 10° C.,
   ii) providing a first liquid gelling agent preparation and introducing the first gelling agent preparation into the organic solvent;
   iii) providing a second solid gelling agent preparation which differs from the first gelling agent preparation and introducing the second gelling agent preparation into the organic solvent,
   wherein the detergent- or cleaning-active ingredient is introduced into the organic solvent after step i), thereby forming a detergent- and cleaning-active composition.
31. The method according to one of the preceding points, wherein a gelling agent preparation is introduced into the organic solvent as a solid gelling agent preparation and the solid gelling agent preparation has a particle size distribution in which at least 70 wt. % of the particles, preferably at least 80 wt. % of the particles, have a particle size below 1000 μm, preferably below 800 μm and in particular below 200 μm.
32. The method according to one of the preceding points, wherein a gelling agent preparation is introduced into the organic solvent as a solid gelling agent preparation and the solid gelling agent preparation, based on its total weight, has a proportion by weight of gelling agent above 60 wt. %, preferably above 80 wt. % and in particular in the range from 85 to 99 wt. %.
33. The method according to one of the preceding points, wherein a gelling agent preparation is introduced into the organic solvent as a liquid gelling agent preparation.
34. The method according to one of the preceding points, wherein a gelling agent preparation is introduced into the organic solvent as a liquid gelling agent preparation and the liquid gelling agent preparation, based on its total weight, has a proportion by weight of gelling agent of from 1 to 20 wt. %, preferably from 2 to 15 wt. % and in particular from 4 to 12 wt. %.
35. The method according to one of the preceding points, wherein a gelling agent preparation is introduced into the organic solvent as a liquid gelling agent preparation and the gelling agent preparation is in the form of a dispersion of the gelling agent in an organic solvent.
36. The method according to point 35, wherein the gelling agent is in the form of particles having a maximum dimension of from 2 to 100 mm, preferably from 5 to 60 mm and in particular from 10 to 30 mm.
37. The method according to point 35 or 36, wherein the gelling agent is in the form of film particles.
38. The method according to one of points 1 to 34, wherein a gelling agent preparation is introduced into the organic solvent as a liquid gelling agent preparation and the gelling agent preparation is in the form of a solution of the gelling agent in an organic solvent.
39. The method according to point 38, wherein the solution of the gelling agent has a temperature of from 30 to 120° C., preferably from 50 to 110° C. and in particular from 70 to 100° C. when it is introduced into the organic solvent initially charged in step i).
40. The method according to one of the preceding points, wherein the weight ratio of the gelling agent introduced by means of a solid gelling agent preparation to the gelling agent introduced by means of a liquid gelling agent preparation is 1000:1 to 20:1, preferably 800:1 to 40:1 and in particular 600:1 to 60:1.
41. The method according to one of the preceding points, wherein method steps ii) and iii) are carried out consecutively.
42. The method according to one of the preceding points, wherein the same gelling agent is introduced into the organic solvent in step ii) and step iii).
43. The method according to one of the preceding points, wherein a gelling agent from the group of the polyvinyl alcohols is introduced into the organic solvent in step ii) and step iii).
44. The method according to one of the preceding points, wherein, after introduction of the first gelling agent preparation in step ii) or after introduction of the second gelling agent preparation in step iii) or after introduction of detergent- or cleaning-active ingredient, the temperature of the organic solvent is raised to a temperature T₂ above the temperature T₁.
45. The method according to point 39, wherein the temperature difference of T₂ to T₁ is at least 20° C., preferably at least 25° C. and in particular at least 30° C.
46. The method according to one of the preceding points, wherein, after step ii) or after introduction of the second gelling agent preparation in step iii) or after introduction of detergent- or cleaning-active ingredient, stirring into the organic solvent takes place for a period of from 0.5 to 12 hours, preferably from 1 to 6 hours and in particular from 1 to 3 hours.
47. The method according to one of the preceding points, wherein a dye is introduced into the liquid detergent- or cleaning-active preparation in a further step iv) after step iii).
48. The method according to one of the preceding points, wherein the liquid detergent- or cleaning-active preparation is portioned in a further step v).
49. The method according to one of the preceding points, wherein, after step iii), preferably after step iv), in a further step v), the liquid detergent- or cleaning-active preparation is poured into a recess.
50. The method according to one of the preceding points, wherein, after step iii), preferably after step iv), in a further step v), the liquid detergent- or cleaning-active preparation is poured into a receiving chamber obtained by deforming a water-soluble film.
51. The method according to one of the preceding points, wherein the liquid detergent- or cleaning-active preparation solidifies after step iii), preferably after step v), upon cooling, to form a gel-like body.

### EXAMPLES

Detergent or cleaning agents having the following composition were produced (data in wt. % based on the total weight of the detergent or cleaning agent):

| | E1 | E2 | E3 | E4 | E5 | E6 | E7 | E8 |
|---|---|---|---|---|---|---|---|---|
| Water-free zinc acetate | 0.5 | 0.5 | 1 | 1 | 0 | 0 | 0.5 | 0.5 |
| Non-ionic surfactant | 2.5 | 4 | 2.5 | 4 | 2.5 | 4 | 7 | 7 |
| Acrylic acid-amidopropyl- | 10 | 10 | 10 | 10 | 10 | 10 | 10 | 10 |
| sulfonic acid copolymer | | | | | | | | |
| Glycerol | 25 | 25 | 25 | 25 | 25 | 25 | 24 | 25 |
| 1,3-propanediol | 30 | 30 | 30 | 30 | 30 | 30 | 28 | 29 |
| PEG 400 | 15 | 15 | 15 | 15 | 15 | 15 | 15 | 14 |
| PVOH | 15 | 15 | 15 | 15 | 15 | 15 | 15 | 14 |
| Misc (inter alia, processing | Add | Add | Add | Add | Add | Add | Add | Add |
| aids, pH-adjusters, perfume, | 100 | 100 | 100 | 100 | 100 | 100 | 100 | 100 |
| dye) | | | | | | | | |

### Method 1

To produce the detergent or cleaning agents, a mixture of glycerol and 1,3-propanediol was heated to a temperature in the range of from 65 to 90° C. Subsequently, non-ionic surfactant, acrylic acid-amidopropyl-sulfonic acid copolymer and optionally zinc acetate were introduced into the solvent mixture. After addition of PEG 400, solid polyvinyl alcohol is added first, followed by a dispersion of polyvinyl alcohol film particles in glycerol (4 wt. % polyvinyl alcohol). The temperature of the mixture is raised to 110 to 140° C. After stirring for three hours, dye is added to the detergent or cleaning agent.

### Method 2

To produce the detergent or cleaning agents, a mixture of glycerol and 1,3-propanediol was heated to a temperature in the range of from 30 to 50° C. After addition of PEG 400, a solution of polyvinyl alcohol in glycerol at a temperature of 85° C. was introduced into the organic solvent. After stirring for two hours, solid polyvinyl alcohol, non-ionic surfactant, acrylic acid-amidopropyl-sulfonic acid copolymer and optionally zinc acetate were introduced into the solvent mixture. The temperature of the mixture is raised to 110 to 140° C. After stirring for three hours, dye is added to the detergent or cleaning agent.

The detergent or cleaning agents resulting from methods 1 and 2 were poured into a receiving chamber obtained by thermoforming a water-soluble polyvinyl alcohol film and cured by cooling.

1. A method for producing a detergent or cleaning agent, the method comprising:
providing an organic solvent at a temperature above 10° C. in an amount of from 30 to 90 wt. %, based on the total weight of the detergent or cleaning agent;
introducing a detergent- and cleaning-active composition into the organic solvent in an amount of from 0.1 to 40 wt. %, based on the total weight of the detergent or cleaning agent;
introducing a first gelling agent preparation into the organic solvent; and
introducing a second gelling agent preparation into the organic solvent,
wherein the second gelling agent preparation is different from the first gelling agent preparation, and
wherein a first gelling agent of the first gelling agent preparation and the second gelling agent of the second gelling agent preparation are in an amount of from 4 to 40 wt. %, based on the total weight of the detergent or cleaning agent.

2. The method of claim 1, wherein the first gelling agent and the second gelling agent are selected from the group consisting of polymeric gelling agents.

3. The method of claim 1, wherein the first gelling agent preparation is in the form of a solid and the second gelling agent preparation is in the form of a liquid.

4. The method a of claim 1, wherein the first gelling agent preparation is in the form of a liquid and the second gelling agent preparation is in the form of a solid.

5. The method of claim 11, wherein the first gelling agent preparation and/or the second gelling agent preparation has a particle size distribution in which at least 70 wt. % of the particles have a particle size below 1000 μm.

6. The method of claim 11, wherein the first gelling agent preparation comprises the first gelling agent in an amount above 60 wt. %, based on the total weight of the first gelling agent preparation, and/or the second gelling agent preparation comprises the second gelling agent in an amount above 60 wt. %, based on the total weight of the second gelling agent preparation.

7. The method of claim 1, wherein the first gelling agent preparation and/or the second gelling agent preparation is in the form of a liquid.

8. The method of claim 7, wherein the first gelling agent preparation comprises the first gelling agent in an amount of from 1 to 20 wt. %, based on the total weight of the first gelling agent preparation, and/or the second gelling agent preparation comprises the second gelling agent in an amount of from 1 to 20 wt. %, based on the total weight of the second gelling agent preparation.

9. The method of claim 1, wherein the first gelling agent and the second gelling agent are the same.

10. (canceled)

11. The method of claim 1, wherein the first gelling agent preparation and/or the second gelling agent preparation is in the form of a solid.

12. The method of claim 2, the first gelling agent and the second gelling agent are selected from the group consisting of polyvinyl alcohols, gelatins, xanthan, and mixtures thereof.

13. The method of claim 12, wherein the first gelling agent and the second gelling agent are selected from the group consisting of polyvinyl alcohols.

14. The method of claim 13, wherein the first gelling agent and the second gelling agent are selected from the group consisting of acetalized polyvinyl alcohols.

15. The method of claim 5, wherein the solid first gelling agent preparation and/or the solid second gelling agent preparation has a particle size distribution in which at least 70 wt. % of the particles have a particle size below 800 μm.

16. The method of claim 15, wherein the solid first gelling agent preparation and/or the solid second gelling agent preparation has a particle size distribution in which at least 80 wt. % of the particles have a particle size below 200 μm.

17. The method of claim 6, wherein the first gelling agent preparation comprises the first gelling agent in an amount above 80 wt. %, based on the total weight of the first gelling agent preparation, and/or the second gelling agent preparation comprises the second gelling agent in an amount above 80 wt. %, based on the total weight of the second gelling agent preparation.

18. The method of claim 17, wherein the first gelling agent preparation comprises the first gelling agent in an amount of from 85 to 99 wt. %, based on the total weight of the first gelling agent preparation, and/or the second gelling agent preparation comprises the second gelling agent in an amount of from 85 to 99 wt. %, based on the total weight of the second gelling agent preparation.

19. The method of claim 8, wherein the first gelling agent preparation comprises the first gelling agent in an amount of from 2 to 15 wt. %, based on the total weight of the first gelling agent preparation, and/or the second gelling agent preparation comprises the second gelling agent in an amount of from 2 to 15 wt. %, based on the total weight of the second gelling agent preparation.

20. The method of claim 19, wherein the first gelling agent preparation comprises the first gelling agent in an amount of from 4 to 12 wt. %, based on the total weight of the first gelling agent preparation, and/or the second gelling agent preparation comprises the second gelling agent in an amount of from 4 to 12 wt. %, based on the total weight of the second gelling agent preparation.

21. The method of claim 1, wherein the liquefaction point of the detergent or cleaning agent is at a temperature above 80° C.
